(19) United States
(12) Patent Application Publication
(10) Pub. No.: US 2003/0004833 A1
(43) Pub. Date: Jan. 2, 2003

(54) Method for vending electronic entertainment

(76) Inventors: Alan Pollak, Metuchen, NJ (US); Thiyagarajan Srinivasan, Delhi (IN)

Correspondence Address: POWELL, GOLDSTEIN, FRAZER & MURPHY LLP, P.O. BOX 97223, WASHINGTON, DC, 20090-7223, US

(21) Appl. No.: 10/178,508

(22) Filed: Jun. 25, 2002

Related U.S. Application Data
(60) Provisional application No. 60/301,300, filed on Jun. 27, 2001.

(51) Int. Cl. G06F 17/60

(52) U.S. Cl. 705/26; 705/1

(57) ABSTRACT

A method for selling entertainment such as music, movies, videos, and personal messages which includes the steps of receiving a music choice from a user, transferring the chosen music to a remote terminal such as a personal computer, storing information regarding the music choice, and receiving payment for the music from a debit system. The method may also use the stored information to determine royalties and adjust pricing for the purchase of subsequent entertainment. The method may also include receiving payment for the entertainment from a prepaid account.

This application claims priority to U.S. Application No. 60/301,300 filed Jun. 27, 2001.

### FIELD OF THE INVENTION

The invention is a system that provides entertainment through the use of software engineering and Internet application technologies in combination with an electronic vending machine. This electronic Entertainment Vending Machine (EVM) is designed to vend music, audio, video, movies, personal messaging, live streaming, and other forms of entertainment. This EVM can monitor, control, and deliver copyrighted information and entertainment such that proper licensing and royalty payments can be made on selected music, movies, videos, and the like when selected and downloaded by a user.

### DESCRIPTION OF RELATED ART

U.S. Pat. No. 4,788,675 discloses a music delivery arrangement permitting a subscriber to select from among a plurality of available music selections that a user wishes to hear at any time. The plurality of music selections are “played” at a central “jukebox” facility. The music selections are frequency multiplexed onto one or more communication channels that are typically used to carry video information, such as a cable television channel. The video channel information is distributed to individual subscribers either via unused channels of a cable television system, by direct broadcast at commercial television frequencies, by direct satellite transmission to a subscriber, or by some other means.

U.S. Pat. No. 5,524,051 discloses a system and method of information dissemination that permits the user to listen to the specific content of information such as music, videos, news, or movies, when and where the user wants to. A radio or television receiver system receives information from an FM subcarrier, a television vertical blanking interval transmission, an active picture area television transmission, a television separate audio program transmission or a dedicated radio channel and stores the transmitted information in a memory. A user interface allows selection from the memory of the stored information via a set of menus controlling a hierarchical database, so as to access particular items of the information.

U.S. Pat. No. 5,675,575 discloses an apparatus and method for transmitting, receiving, and communicating program data signals such as music, videos, games, and computer software which are combined with digital data signals. Preferably, the apparatus compresses 30 digital audio signals, multiplexes them with the music, title, track, artist, record label, year, etc., program information, and transmits the combined signals via satellite to a receiving station.

U.S. Pat. Nos. 5,721,827; 5,732,216; and 6,199,076 B1 disclose an audio program and message distribution system in which a host system organizes and transmits program segments such as music, videos, personal messages, etc. to client subscriber locations. The host organizes the program segments by subject matter and creates scheduled programming in accordance with preferences associated with each subscriber. Program segments are associated with descriptive subject matter segments, and the subject matter segments may be used to generate both text and audio cataloging presentations to enable the user to more easily identify and select desirable programming. A playback unit at the subscriber location reproduces the program segments received from the host and includes mechanisms for interactively navigating among the program segments. A usage log is compiled to record the subscriber's use of the provided program materials, to return data to the host for billing, to adaptively modify the subscriber's preferences based on actual usage, and to send subscriber-generated comments and requests to the host for processing. Voice input and control mechanisms included in the player allow the user to perform hands-free navigation of the program materials and to dictate comments and messages which are returned to the host for retransmission to other subscribers. This prior art system is very complex and needs a large amount of user input and computer navigating to receive specific programming segments. Also, this prior art system does not have the simplicity of the electronic Entertainment Vending Machine (EVM), according to the present invention.

U.S. Pat. No. 5,809,246 discloses a method for the selection and retrieval of music from a digital database of a digital radio broadcast station wherein the station includes a plurality of at least several hundred (preferably at least 1800) different selections of music to be played and broadcast by the radio station. A processor system is provided for programming the operation of the digital radio broadcast station with a sequence of music selections, which are subsequently retrieved in order from the common digital database and played over the digital radio broadcast station. The processor system is also provided with a connection to a telephone network, such that radio station callers can communicate with the radio station by a touch tone telephone, and is also provided with a connection to an interactive cable television network, such that cable television viewers can communicate with the radio station over the interactive cable television network.

U.S. Pat. No. 6,192,340 B1 discloses a method for the integration of music from a personal library with real-time information. The apparatus includes communicating, processing and playing means, as shown in FIGS. 1 and 4 of the drawings. The method includes the steps of: communicating a user's information preferences to an information provider; receiving from the information provider informational items that are responsive to the user's information references; interleaving and sequencing a playing of the received informational items with a playing of a plurality of musical items included in an audio library of the user; and playing, which is responsive to the interleaving and sequencing, the received informational items within a playing of the plurality of musical items. The playing includes a voice synthesizing of an at least one of informational item. The playing is responsive to a schedule preferences of the user; wherein a verified apparent listening to an informational item is associated with a credit; and/or wherein, the playing is responsive to schedule preferences of the user.

The above patents do not disclose or teach the concept of an electronic Entertainment Vending Machine (EVM) in conjunction with a personal computer for vending entertainment such as music, videos, movies or personalized messaging as shown in the present invention.

### SUMMARY OF THE INVENTION

There is provided according to the present invention a method of selling entertainment such as music, movies, videos, and personal messages which includes the steps of receiving a music choice from a user, transferring the chosen music to a remote terminal, storing information regarding the music choice, and receiving payment for the music from a debit system. There is also provided according to the present invention a method for selling entertainment which uses stored information to determine royalties and adjust pricing for the purchase of subsequent entertainment. There is also provided according to the present invention a method for selling entertainment which receives payment from a prepaid account.

Further objects, features, and advantages of the invention will become apparent from the detailed description that follows.

### DETAILED DESCRIPTION OF THE INVENTION

The electronic Entertainment Vending Machine (EVM) methodology is an easy-to-use and integrated system which allows for the speedy control and quality downloading of entertainment selections by the user. Entertaiment can be music, audio, movies, videos, personal messages, and any other digitally exploitable entertainment. The principles inherent in the old-fashioned vending machine have been transformed to operate within the world of the Internet. In addition, unlike subscription systems, Applicants have modeled the user payment policy on the E-ZPass toll collection system or debit system in which there is a balance reduction of a prepaid account as each individual transaction occurs. This system can allow the purchaser of entertainment to see the value of each transaction. This monetization of intellectual capital differs from existing systems. This system is not a peer-to-peer technology. Music rests on a server, which gives absolute control of quality and downloading speed. Specific information such as who is choosing the entertainment, what entertainment is being chosen, when it is chosen, and where it is being downloaded can be known and stored for future reference. The back-end (management) system helps to create the business relationship between the music industry (e.g., record labels) and Applicants, and also allows greater control avoiding the downloading problems that frequently occur.

Unlike a subscription system for purchasing entertainment, the music industry can monetize individual artists such that when downloading occurs, there is price control. Entertainment by popular artists will cost more than that of less popular artists. Catalogs, artists, retailers and other distribution mechanisms can easily be incorporated into the EVM method because the controls are already in place. Downloading of entertainment does not have to be done in real time, but can be zipped. The consumer benefits from this because of the ease and simplicity of the operation and because the present vending machine allows one to get a free sample of the product for 15 seconds before one commits to downloading the full selection. Therefore, the user can be sure that they like the song and it is the correct version before purchasing it. The EVM methodology provides a solution to the problems associated with subscription models. The debit function will allow the record labels and other entertainment companies to collect more money at the end of the day, giving them a better retail opportunity to mark up or discount the individual artists. This will also tie into the back-end accounting package and can give rapid and accurate royalty payments. The prepaid account system makes the transaction quick, easy, and convenient for the user. There is no handling of coins or paper currency. All financial transactions can be performed electronically.

The music buyer is less likely to sign up for a wide variety of subscriptions when they can just keep a debit account with the. EVM and use it at their convenience. Traditionally, a buyer may pay $10 to $20 per month to have 5 or 6 different services. The EVM methodology allows a user's account to be automatically be replenished as with an EZPass system. In the alternative, a buyer can replenish their account when in use. This is possible because Applicants can send the user an e-mail (or possibly notification on the website itself, if the user is in the process of downloading entertainment), if the debit balance has become too low.

Additionally, the present invention allows for the possibility of a computer crashing or a system going down during a period when the user has logged on and made their selections. In this event, once the system starts again, the EVM remembers where it was and continues the operation, so the consumer can be assured that he receives everything for which he has paid.

The EVM can be crafted with software, computer technology, the Internet, and personal communication systems to provide non-stop entertainment vending on the Internet. The invention allows the power of the Internet to provide entertainment across the globe through the system of entertainment vending.

The present invention is illustrated by the following examples which should not be considered limiting.

Sample Operation

Step 1. User will come to the website and click on the JOIN button. This will take them to a form, in which they will fill out information about themselves. At this time they are given a username and password.

Step 2. With the assigned username and password, the user can log into the EVM. Once they are logged on, they can click on the DEPOSIT button, which will bring them to the DEPOSIT form. The form will allow them to put a deposit into their account, which allows them to purchase songs. When a user's balance reaches a minimum, the user will receive a message letting them know to make another deposit. They will also have the option to have their balance automatically increased when it reaches a set amount.

Step 3. With a balance in their account, the user can search for a song by artist name, song title, or music type. When they have found the song they searched for, they will click on the SELECT button. This will enter the selected song in the SELECTION box on the EVM.

Step 4. With a song in the SELECTION box, the user has the opportunity to listen to a free sample of that selected song by clicking on the SAMPLE button.

Step 5. Once the user has confirmed that the selected song is what they would like to purchase, they can click on the DOWNLOAD button. The DOWNLOAD button starts the download process of the song to the user's computer, and at the same time, subtracts the cost of that song from their balance.

Step 6. Clicking on the FUTURE RELEASES button opens a separate window containing a list of songs that will be available at a future date. When a song is chosen, email will be sent to let the user know when it is available.

The following example is a description of a dedicated hardware version of the EVM. This version is used substantially or exclusively for electronic entertainment vending. The technology remains exactly the same. The EVM can be placed in an environment other than an individual's laptop or desktop computer. The concept allows Applicants to license the necessary hardware to utilize the EVM in many different environments.

An EVM may be placed in the first-class lounge of an airline. It can become another distribution mechanism for the sale of compact discs (i.e., CD's). As a marketing tool, the EVM has the following functions. A passenger (i.e., consumer) is given a free, blank CD, compliments of both the airline and an advertiser. The consumer can go over to the EVM and download several songs. The EVM normally operates as an EZPass type of payment method where the user would have already entered his or her credit card and will draw against a prepaid account. However, in this case, an adjustment is made so the music is downloaded and the user does not have to pay. Applicants cover the royalties with the music industry, and licensing revenues are obtained from advertisers. Should the user wish to do more on the EVM, he has the option of going through the electronic process of entering credit card information and downloading entertainment at his own expense.

Another example of a dedicated hardware version is a retail unit that a licensee would place in a large department store. A CD may be purchased which contains songs that the user would compile with the EVM.

Since the EVM lends itself to audio and video commercials, part of its revenue stream may generated by selling advertising space. The dedicated hardware version of the EVM allows Applicants to become part of the major distribution system of the music industry. It allows Applicants to present to the music industry opportunities for selling CDs and promoting new artists in areas where major CD sales do not take place in the general retail environment. It also acts as a mechanism to promote new artists and download their CDs in areas that may sell CDs in general, but incurring the additional expense of carrying inventory on non-popular or new artists would be necessary. This concept can also be carried over to hotels. People can have the opportunity to choose the music they like similar to how they pay for watching a movie. However, the distribution method for personalized selection and downloading music or videos as disclosed by the present invention is unique.

Those skilled in the art, having the benefit of the teachings of the present invention as hereinabove set forth, can effect numerous modifications thereto. These modifications are to be construed as being encompassed within the scope of the present invention as set forth in the appended claims.

What is claimed:

1. A method of selling music comprising the following steps of:
receiving a music choice from a user,
transferring chosen music to a remote terminal,
storing information regarding said music choice, and
receiving payment for said music from a debit system.

2. The method of claim 1, wherein said information is used to determine royalties.

3. The method of claim 1, wherein said information is used to adjust pricing of a subsequent music choice.

4. The method of claim 1, wherein said remote terminal is a personal computer.

5. The method of claim 1, wherein said remote terminal is used substantially for selling music.

6. The method of claim 1, further comprising downloading said music onto a compact disc.

7. The method of claim 1, wherein said transferring is done over the INTERNET.

8. The method of claim 1, wherein said music is stored on a server before being chosen.

9. The method of claim 1, wherein more than one choice of music is made.

10. The method of claim 9, wherein payment is made after each choice of music.

11. A method of selling a movie comprising the following steps of:
receiving a movie choice from a user,
transferring a movie to a remote terminal,
storing information regarding said movie choice, and
receiving payment for said movie from a debit system.

12. The method of claim 11, wherein said information is used to determine royalties.

13. The method of claim 11, wherein said information is used to adjust pricing of a subsequent music choice.

14. The method of claim 11, wherein said remote terminal is a personal computer.

15. The method of claim 11, wherein said remote terminal is used substantially for selling movies.

16. The method of claim 11, wherein said transferring is done over the INTERNET.

17. The method of claim 11, wherein said movie is stored on a server before being chosen.

18. The method of transferring personal messages to a remote terminal comprising the step of receiving payment for said transfer of message from a debit system.
